(19) United States
(12) Patent Application Publication
(10) Pub. No.: US 2003/0000320 A1
(43) Pub. Date: Jan. 2, 2003

(54) Automatic inspection device for optical disc

(76) Inventor: Meng-Chi Tsai, Jongli City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/892,493

(22) Filed: Jun. 28, 2001

(51) Int. Cl. G01M 19/00

(52) U.S. Cl. 73/865.8

(57) ABSTRACT

An automatic inspection device for optical disc is disclosed. The inspection device comprises an inspection platform; a vertical elevating mechanism located on the inspection platform; a rotating shaft located at one lateral side of the vertical elevating mechanism, a servo-rotating device located at the lower section of the rotating shaft to drive the driving shaft to rotate clockwise or counterclockwise; a rotating disc mounted onto the rotating shaft driven; a suction arm mounted to the circumferential edge of the rotating disc; a to-be-tested seat and feed-discharging seat located on the track of the circular swing of the circumference of the suction arm; and an optical disc inspection device having a retractable tray for the positioning of the to-be-tested optical disc for inspection and recording the results of the inspection.

### BACKGROUND OF THE INVENTION

(a) Field of the Invention

The present invention relates to an automatic inspection device for optical disc, and in particular, to an inspection device, which can automatically retrieve, position and inspect an optical disc.

(b) Description of the Prior Art

Optical discs are widely used in recording digital data, music, images and movies, and the optical disc has the advantages of conveniently retrieve and/or read information therefrom, small storage of the data and the data permanently stored. Optical discs are widely produced by molding digital music data onto the disc. For instance, the CD-R optical discs, which can store large volume of data, is by optical single recording method and then is duplicated and burn data onto the optical disc. No matter how the data is recorded, the completeness of the recording on the optical disc has to be inspected one by one so as to eliminate defect products.

In the optical disc manufacturing industries, the optical discs are inspected manually to check the data in the optical discs. Therefore, it is laborious and time wasting, and cost of production is increased. Furthermore, due to long working hours of the operators, errors may occur in the course of inspection and this will affect the quality and performance of the inspected optical disc.

### SUMMARY OF THE INVENTION

Accordingly, it is an object of the present invention to provide an automatic inspection device for optical disc, wherein the inspection platform is mounted with a vertical elevating mechanism, a rotating disc and a suction arm, thereby an up and down vertical movement and horizontal circumferential movement to retrieve and position of an optical disc are obtained. Thus, large amount of time, and manpower and cost are saved with respect of inspection of the optical disc.

Yet another object of the present invention to provide an automatic inspection device for optical disc, wherein the operator will not feel tire and the shortcomings as a result of tiredness of the operator in the conventional inspection device is overcome.

A further object of the present invention to provide an automatic inspection device for optical disc, wherein human errors in the inspection is overcome.

Other objects and advantages of the present invention will become more apparent from the following description taken in conjunction with the accompanying drawing.

### BRIEF DESCRIPTION OF THE DRAWINGS

FIG. 1 is a perspective view of an automatic inspection device for optical disc of the present invention.

FIG. 2 is an elevational view showing the driving of the elevating seat by the vertical elevating mechanism in an up-and-down vertical movement.

FIG. 3 is a top view of the automatic inspection device for optical disc of the present invention.

FIG. 4 is a partial enlarged view, showing the rotating disc and the suction arm to retrieve and position an optical disc on the tray in accordance with the present invention.

### DETAILED DESCRIPTION OF THE PRESENT INVENTION

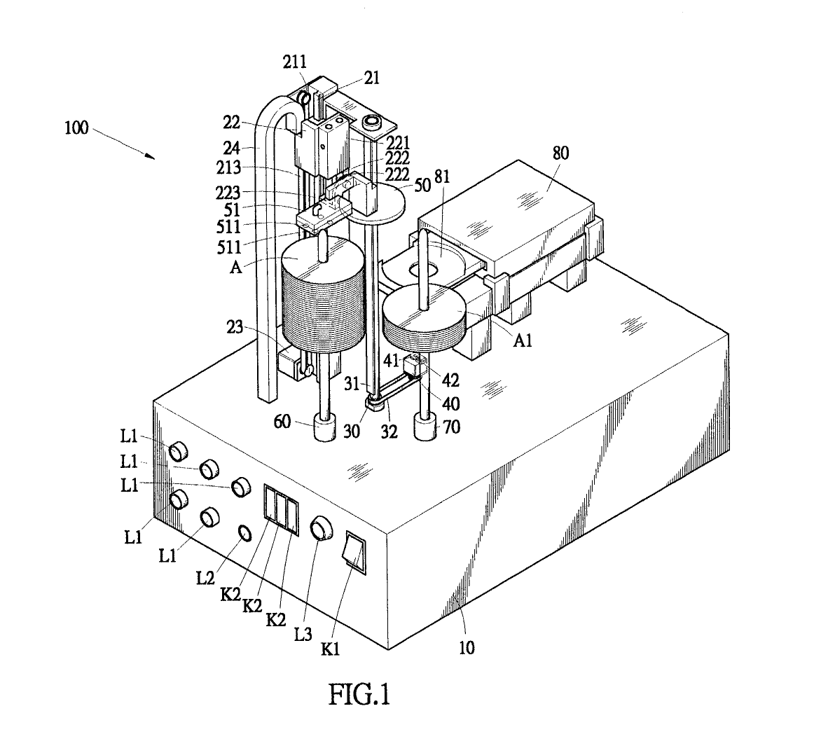

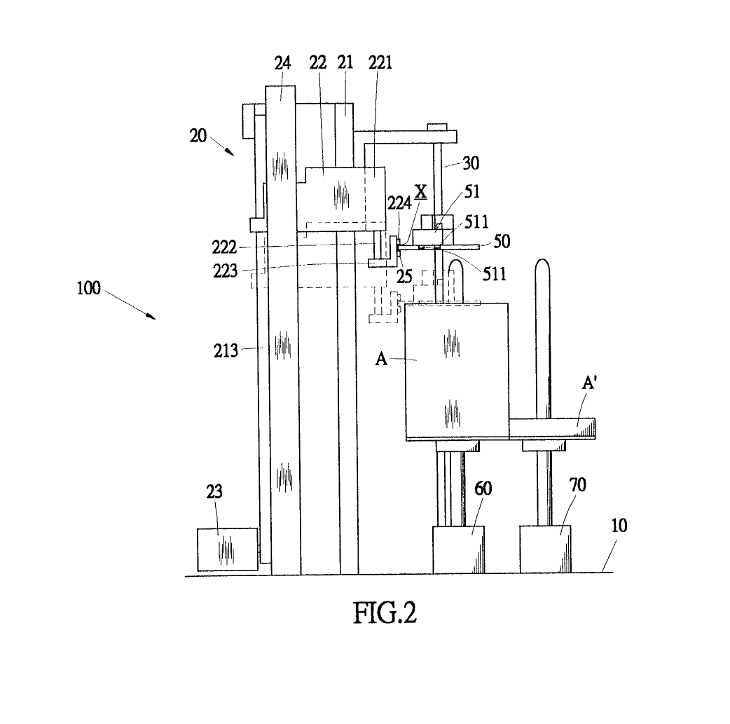

Referring to FIGS. 1 and 2, there is shown an automatic inspection for optical disc. The inspection device 100 comprises an automatic inspection device for optical disc comprising an inspection platform 10 and the circumferential edge of the inspection platform 10 is provided with a plurality of indicators L1, L2, L3 and operation buttons K1, K2, to indicate the operation status and to preset operation. An vertical elevating mechanism 20 is located on the inspection platform 10 and the elevating mechanism 20 include a vertical rail 21 having an elevating seat 22 which can move along the vertical rail 21 in an up-down movement. Rotating wheels 211, 212 are mounted to the top and bottom end of the rail 21 and a belt 213 is used to link the two wheels 211, 212. A driving device 23 id mounted to the rotating wheel 212 which controls the elevating seat 213 to move up and down. The elevating seat 22 is joined to one end of the belt 213. The elevating seat moves along the vertical rail 21 by means of the belt 213 and the driving device 23 (as shown in FIG. 2).

One lateral side of the elevating seat 22 is provided with a position device 221, and in the present invention, the device is a pneumatic cylinder type. An engaging seat 223 is an L-shaped structure which move up and down by an actuating rod 222 and a transverse rail 224, 225 are located at the circumferential edge thereof. A gap x is formed between the transverse rails 224, 225. A flexible conduit 24 is linked to one end of the elevating seat 22 for the holding of the controlling pipe and pneumatic control conduits so as to protect these conduits in the course of retraction and extension.

The rotating shaft 30 is located at one lateral side of the vertical elevating mechanism 10 and a button 31 is provided on the surface thereof. The lower end of the rotating shaft is a belt 32 joined to a servo-rotating device 40 located at the lower section of the rotating shaft 30 to drive the driving shaft 41 to rotate clockwise or counterclockwise. An optical sensor 42 is located on the rotating shaft 41 to sense the movement position of the servo-rotating device 40.

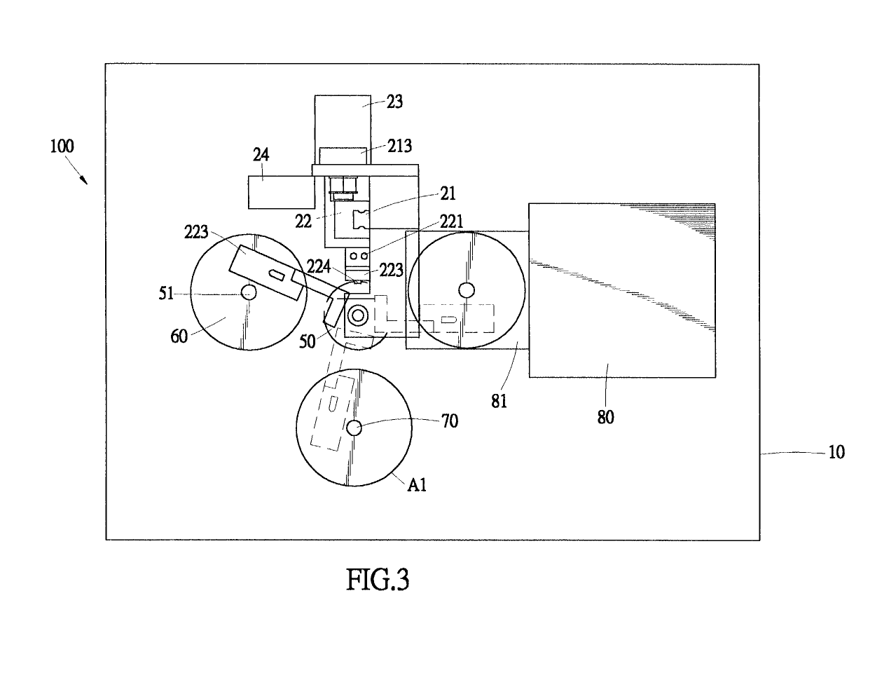

The rotating disc 50 is mounted onto the rotating shaft 41 driven by a driving-rotating device 40 so as to rotate clockwise or counterclockwise horizontally and the circumferential edge is engaged with the two transverse rails 224, 225 of the engaging seat 223 and driven to elevate by the vertical elevating mechanism 10. A gap x is formed between the transverse rails 224, 225. A suction arm 51 is mounted to the circumferential edge of the rotating disc 50 and is rotated together with the rotating disc 50 clockwise or counterclockwise and is having a plurality of suction discs 51 at the bottom end thereof to suck and retrieve the to-be-tested optical disc A and the tested optical disc A′ (as shown in FIG. 3).

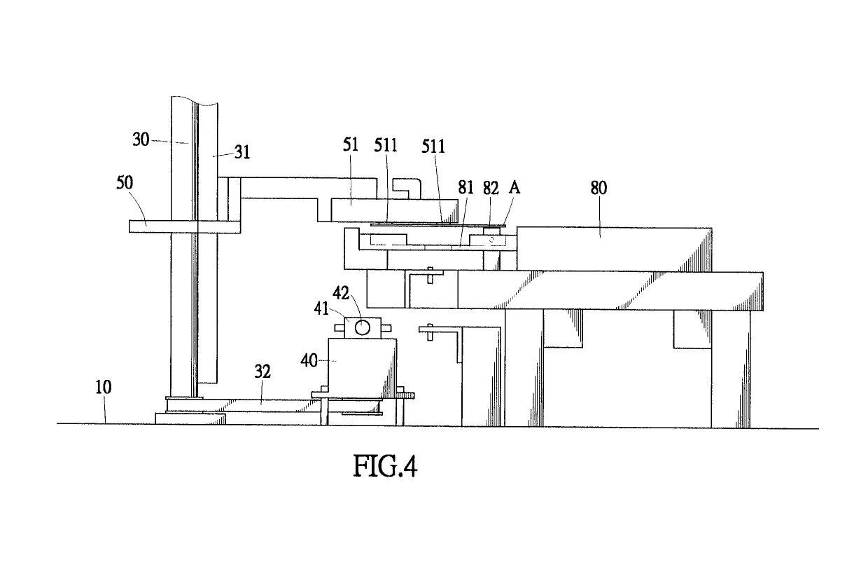

A to-be-tested seat 60 and a feed-discharging seat 70 are respectively located on the track of the circular swing of the circumference of the suction arm 51 of the inspection platform 10 so as to respectively stack a plurality of to-be-tested optical discs A and the test-completed optical discs A′. The optical disc inspection device 80 is provided with a rotating tray 50 for the positioning of the to-be-tested optical discs A for inspection and recording the results of the inspection, and swings circumferentially along the position of the track. The optical inspection device 80 includes a tray 81, which can extend and retract to allow the suction arm 51 with the to be-tested optical disc to be placed thereon. One lateral side of the tray 81 is provided with a sensor 82 (referring to FIG. 4) and when the tray moves outward, the position of the optical disc A can be inspected and the optical inspection device 80 can proceed with the inspection of the optical disc A. Thus the result of the inspection is recorded and the defect products are discarded.

As shown in FIGS. 1 and 2, the indicators L1, L2, L3 and the operation buttons K1, K2, the vertical elevating mechanism 20, the servo-driving device 40, the suction arm 51 and the individual light indications, command inputs, operational control and inspection results of the optical disc inspection device 80, can be controlled and determined by Programmable Controller (PLC) or computer (not shown).

Referring to FIGS. 3 and 4, in operation, the rotating shaft 30 is rotated by the servo-driving device 40 so as to drive the rotating disc 50 to rotates one circumferential angle counterclockwise, and the suction arm 51 reaches the top position (as shown in FIG. 3) of the to-be-tested seat 60. Then, by means of the driving device 23 of the elevating device 20, the elevating seat 22 drives the suction arm 51 to descend to the position of the first to-be-tested optical disc A of the to-be-tested seat 60. The positioning device 221 moves the suction arm 51 downward to contact with the to-be-tested optical disc A. The suction disc 511 sucks the to-be-tested optical disc A, and the elevating mechanism 20 pulls the suction arm 51 upward to the original height. The servo-driving device 40 rotates the rotating disc 50 for another counterclockwise direction for one circumferential angle to the tray 81 of the optical disc inspection device 80. The elevating device 20 moves downward the suction arm 51 to the top position of the tray 81 (as shown in FIG. 4). The positioning device 221 places the to-be-tested optical disc A onto the tray 8 and the suction disc 511 releases the to-be-tested optical disc A onto the tray 8. Then, the positioning device 221 moves upward the suction arm 51 to release the suction disc 81. At this instance, the sensor 82 sense the to-be-tested optical disc A is at the tray 81, then the tray 82 returns the optical disc A to the optical inspection device such that the to-be-tested optical disc A can be proceeded to inspection.

When the optical disc A has been tested, and recorded, the results thereof are stored for reference. By reversing the above operational procedures, the suction arm 51 sucks the test-completed optical disc A′ and the reverse rotation of the servo-driving device 40 causes the rotating disc 50 and the suction arm 51 to rotate a circumferential angle to the top of the feed-discharging seat 70. The elevating mechanism 20, similar to that of the FIG. 2, retrieves the test-completed optical disc A′ to the feed-discharging seat 70. By repeating this procedures, the optical disc A′ after inspection are stacked.

Accordingly, the present invention provides an automatic inspection for optical disc, wherein the optical disc can be automatically retrieved, inspected and stacked. In view of the above, the automatic retrieval of optical discs, inspection and treatment of the tested optical discs save plenty of working hours, manpower, and capital. Furthermore, the quality and efficiency of inspection of the optical discs are greatly improved.

While the invention has been described with respect to preferred embodiment, it will be clear to those skilled in the art that modifications and improvements may be made to the invention without departing from the spirit and scope of the invention. Therefore, the invention is not to be limited by the specific illustrative embodiment, but only by the scope of the appended claims.

1. An automatic inspection device for optical disc comprising
(a) an inspection platform;
(b) a vertical elevating mechanism located on the inspection platform including a driving device in controlling an elevating seat to move up and down and one lateral side of the elevating seat being provided with an engaging seat having a transverse rail at the circumferential edge thereof;
(c) a rotating shaft located at one lateral side of the vertical elevating mechanism,
(d) a servo-rotating device located at the lower section of the rotating shaft to drive the driving shaft to rotate clockwise or counterclockwise;
(e) a rotating disc mounted onto the rotating shaft driven by a driving-rotating device so as to rotate clockwise or counterclockwise horizontally and the circumferential edge being engaged with the two transverse rails of the engaging seat and driven to elevate by the vertical elevating mechanism;
(f) a suction arm mounted to the circumferential edge of the rotating disc and being rotated together with the rotating disc clockwise or counterclockwise and having a plurality of suction discs at the bottom end thereof;
(g) a to-be-tested seat and feed-discharging seat located on the track of the circular swing of the circumference of the suction arm and respectively stacked a plurality of to-be-tested optical disc and test-completed optical disc; and
(h) an optical disc inspection device having a retractable tray for the positioning of the to-be-tested optical disc for inspection and recording the results of the inspection;
characterized in that the suction arm in combination with the servo-rotating device and the vertical elevating mechanism respectively rotates in a horizontal circumferential angle and vertically descending to the to-be-tested seat, the suction disc retrieves the to-be-tested optical disc and then the servo-rotating device drives the suction arm to rotate at a circumferential angle to the top section of the optical inspection device, and the optical disc is placed onto the tray, the optical inspection device proceeds to inspect the optical disc and record the result of the inspection, then the suction arm proceeds to place the test-completed disc into the feed-discharging seat in combination with the servo-rotating device and the vertical elevating mechanism.

2. The automatic inspection device for optical disc of claim 1, wherein the circumferential edge of the inspection platform is provided with a plurality of indicators and operation buttons to show the operation status and settings.

3. The automatic inspection device for optical disc of claim 1, wherein the vertical elevating mechanism is provided with a vertical rail for the linking of the elevating seat.

4. The automatic inspection device for optical disc of claims 1 or 3, wherein the top and bottom end of the vertical rail is mounted respectively with a rotating wheel linked with a belt and the elevating seat linked to the belt, and one of the rotating wheels linked to a driving device, allowing the elevating seat to move up and down.

5. The automatic inspection device for optical disc of claim 1, wherein the driving device of the vertical elevating mechanism is a servomotor.

6. The automatic inspection device for optical disc of claim 1, wherein the one lateral side of the elevating seat of the vertical elevating mechanism is mounted with a positioning device having an actuating rod linked to the engaging seat to control the up-down movement of the engaging seat.

7. The automatic inspection device for optical disc of claim 6, wherein the positioning device is a pneumatic cylinder.

8. The automatic inspection device for optical disc of claim 1, wherein the engaging seat is “L”-shaped.

9. The automatic inspection device for optical disc of claim 1, wherein the external section of the rotating shaft is provided with a button for linking with a rotating disc.

10. The automatic inspection device for optical disc of claim 1, wherein the servo-rotating device is a servomotor.

11. The automatic inspection device for optical disc of claim 1 or 10, wherein the rotating shaft of the servo-rotating device is provided with a sensor to sense the circumferential angle and rotating position of the rotation of the rotating shaft.

12. The automatic inspection device for optical disc of claim 11, wherein the sensor is an opti sensor type of sensor.

13. The automatic inspection device for optical disc of claim 1, wherein one lateral side of the optical inspection device is provided with a sensor to sense the presence of the optical disc on the tray.
